(19) United States
(12) Patent Application Publication
(10) Pub. No.: US 2026/0022948 A1
(43) Pub. Date: Jan. 22, 2026

(54) REAL-TIME ASSET MAPPING USING UNMANNED AERIAL VEHICLES

(71) Applicant: HERE Global B.V., Eindhoven (NL)

(72) Inventors: Dev SAVLA, Mumbai (IN); Senjuti SEN, West Bengal (IN); Karan SAHU, Pulgaon, Dist: Wardha (IN); Deekshant SAXENA, Navi Mumbai (IN); Abhishek PANDEY, Dwarka New Delhi (IN)

(21) Appl. No.: 18/666,461

(22) Filed: May 16, 2024

(51) Int. Cl. G01C 21/00; B64U 20/80; B64U 101/30; G06V 10/26; G06V 10/774; G06V 20/17

(52) U.S. Cl. CPC G01C 21/3852; B64U 20/80; G06V 10/26; G06V 10/774; G06V 20/17; B64U 2101/30; B64U 2201/20

(57) ABSTRACT

The disclosure provides an unmanned aerial vehicle, a method, and an apparatus for real-time asset mapping. The unmanned aerial vehicle is configured to, for example, control an image sensor to capture an image of a geographical region. Further, the unmanned aerial vehicle is configured to detect a first object of a set of objects in the captured image based on a segmentation of the captured image into one or more segments. The unmanned aerial vehicle is further configured to generate an association between the detected first object and the captured image. Further, the unmanned aerial vehicle is configured to transmit the generated association to a map database.

### TECHNOLOGICAL FIELD

The present disclosure generally relates to real-time asset mapping and more particularly relates to real-time asset mapping using unmanned aerial vehicles.

### BACKGROUND

With advancements in the field of image processing and machine learning, various techniques for asset mapping are known in the art. Asset mapping, a core discipline in surveying and asset management, involves the identification and spatial marking of various assets, owned by an individual or a corporation, on a map. Generally, asset mapping is mainly done to gain knowledge about the location, of various assets in an area so that their certain characteristics associated with the location (such as usage) may be observed so that it can be used more efficiently.

Currently, most of the asset mapping for various applications is done manually. Specifically, a video of the location is recorded and then further processed manually to map one or more assets in the recorded video. Such manual solutions involve a huge cost as well as a lot of manual labor is required. Also, such manual solutions are very cumbersome, time-consuming, and result in a lot of errors. For example, such errors might include human errors, inaccurate location of assets due to manual location mapping, and omission of some areas being surveyed due to the division of work between multiple human surveyors.

Therefore, there is a requirement for an inexpensive, less cumbersome, and accurate solution for real-time asset mapping.

### BRIEF SUMMARY

The present disclosure provides an unmanned aerial vehicle (UAV), a method, and an apparatus with edge processing capabilities to detect assets in real-time. The UAV may have a camera and a GPS sensor. Some embodiments provide deep learning-based image processing which leverages multi-threading architecture to efficiently utilize entire CPU power, providing for faster and efficient image processing. The UAV may capture the images of geographical locations and process them using lightweight machine learning models for object detection and further generate associations between the detected objects and the captured geographical images. The UAV may transmit these associations to the map database in real-time.

The multi-threaded architecture may use a parallelized approach for image processing and may segment the captured image for processing by available cores of the CPU for faster and more efficient image processing. The disclosure further discloses the functionality of combining the processed image from each of the available cores of the CPU and collating the processed image for further usage and analysis applications.

Example embodiments of the present disclosure provide an unmanned aerial vehicle, a method, and an apparatus for real-time asset mapping using unmanned aerial vehicles to overcome the challenges discussed above, and to provide the solutions envisaged as discussed above.

In one aspect, an unmanned aerial vehicle for real-time asset mapping using unmanned aerial vehicles is disclosed. An unmanned aerial vehicle (UAV) may include a processor configured to control an image sensor to capture an image of a geographical region. Further, the processor may be configured to detect the first object of a set of objects in the captured image based on a segmentation of the captured image into one or more segments. The processor may be further configured to generate an association between the detected first object and the captured image. The processor may be further configured to transmit the generated association to a map database.

In additional unmanned aerial vehicle embodiments, the processor may be configured to determine location information associated with the geographical region based on the captured image. The processor may be further configured to transmit the determined location information to the map database.

In additional unmanned aerial vehicle embodiments, the processor may be configured to control a location sensor to capture location information associated with the geographical region. The processor may be further configured to transmit the captured location information to the map database.

In additional unmanned aerial vehicle embodiments, the processor may be configured to apply a first machine learning (ML) model on one or more segments of the captured image. The ML model is trained using a training dataset. Further, the processor may be configured to detect the first object in the captured image based on the application of the first ML model on one or more segments.

In additional unmanned aerial vehicle embodiments, the processor may be configured to retrieve, for training the first ML model, the training dataset associated with the detection of the set of objects in a training image. The processor may be further configured to train the first ML model based on the retrieved training dataset.

In additional unmanned aerial vehicle embodiments, the processor may be configured to apply a second machine learning (ML) model on the detected first object and the captured image. The processor may be further configured to generate the association between the detected first object and the captured image based on the application of the second ML model on the detected first object and the captured image.

In additional unmanned aerial vehicle embodiments, the UAV comprises a memory. The processor may be configured to detect a network event indicative of a disruption in a network connection of the UAV with the map database. The processor may be further configured to store the generated association in the memory based on the detection of the network event.

In additional unmanned aerial vehicle embodiments, the processor may be configured to receive one or more navigation commands associated with the navigation of the UAV from a user device. The processor may be further configured to control the navigation of the UAV towards the geographical region based on the received one or more navigation commands. Further, the processor may be configured to control the image sensor to capture the image of the geographical region based on a determination that the UAV is over the geographical region.

In additional unmanned aerial vehicle embodiments, the processor may be further configured to segment, using a master process, the captured image into one or more segments. The processor may be further configured to allocate, using the master process, the one or more segments of the image to one or more cores of the processor of the UAV.

In additional unmanned aerial vehicle embodiments, the processor may be further configured to determine count data associated with one or more cores of the processor of the UAV. The processor may be further configured to segment the captured image into one or more segments based on the determined count data. Further, the processor may be configured to detect the first object in the captured image using one or more cores of the processor of the UAV.

In additional unmanned aerial vehicle embodiments, the count data may be indicative of a number of available cores of the processor of the UAV, for detecting the first object in the captured image.

In additional unmanned aerial vehicle embodiments, each of the one or more segments of the image is associated with a segment identifier and each of one or more cores of the processor is associated with a core identifier.

In additional unmanned aerial vehicle embodiments, the processor is further configured to combine each of the one or more segments of the image based on the segment identifier and the core identifier.

In another aspect, a method for real-time asset mapping using unmanned aerial vehicles is disclosed. The method may include controlling, by an electronic device, an image sensor to capture an image of a geographical region. Further, the method may include detecting, by the electronic device, the first object of a set of objects in the captured image based on a segmentation of the captured image into one or more segments. The method may further include generating, by the electronic device, an association between the detected first object and the captured image. The method may further include transmitting, by an electronic device, the generated association to a map database.

In additional method embodiments, the electronic device corresponds to an unmanned aerial vehicle (UAV).

In additional method embodiments, the method may include applying, by the electronic device, a first machine learning (ML) model on the one or more segments of the captured image. The ML model is trained using a training dataset. The method may further include detecting, by the electronic device, the first object in the captured image based on the application of the first ML model on the one or more segments.

In additional method embodiments, the method may include applying, by the electronic device, a second machine learning (ML) model on the detected first object and the captured image. The method may further include generating, by the electronic device, the association between the detected first object and the captured image based on the application of the second ML model on the detected first object and the captured image.

In additional method embodiments, the method may include receiving, by the electronic device, one or more navigation commands associated with the navigation of the electronic device from a user device. The method may further include controlling, by the electronic device, navigation of the electronic device towards the geographical region based on the received one or more navigation commands. The method may further include controlling, by the electronic device, the image sensor to capture the image of the geographical region based on a determination that the electronic device is over the geographical region.

In additional method embodiments, the method may further include detecting, by the electronic device, a network event indicative of a disruption in a network connection of the electronic device with the map database. The method may further include storing, by the electronic device, the generated association in a memory based on the detection of the network event.

In another aspect, an apparatus for real-time asset mapping using unmanned aerial vehicles is disclosed. The processor may be configured to control one or more sensors to capture sensor data corresponding to a geographical region. Further, the processor may be configured to process the captured sensor data using one or more cores of the processor to detect the first object of a set of objects. The processor may be further configured to generate an association between the detected first object and the captured sensor data. The processor may be further configured to transmit the generated association to a map database.

In additional apparatus embodiments, the apparatus corresponds to an unmanned aerial vehicle (UAV). The one or more sensors comprise a galvanometer sensor, a hall effect magnetometer sensor, a corona discharge meter sensor, or any other electric field measuring sensor.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a schematic diagram of a network environment of an unmanned aerial vehicle for real-time asset mapping, in accordance with an example embodiment;

FIG. 2 illustrates a block diagram of the unmanned aerial vehicle of FIG. 1, in accordance with an example embodiment;

FIG. 3 illustrates a block diagram of a method for image processing using segmentation, in accordance with one or more example embodiments;

FIG. 4 illustrates a block diagram of an image segmentation pipeline for real-time asset mapping, in accordance with one or more example embodiments;

FIG. 5A illustrates a block diagram of another image segmentation pipeline for image processing, in accordance with one or more example embodiments;

FIG. 5B illustrates a block diagram of the application of an image segmentation pipeline for real-time asset mapping, in accordance with one or more example embodiments;

FIG. 6 illustrates a flow chart of a method for real-time asset mapping, in accordance with one or more example embodiments; and

FIG. 7 illustrates a flow chart of another method for sensor data processing, in accordance with one or more example embodiments

FIG. 8 illustrates an exemplar map database record storing data, in accordance with one or more example embodiments;

FIG. 9 illustrates another exemplar map database record storing data, in accordance with one or more example embodiments;

FIG. 10 illustrates another exemplar map database storing data, in accordance with one or more example embodiments;

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

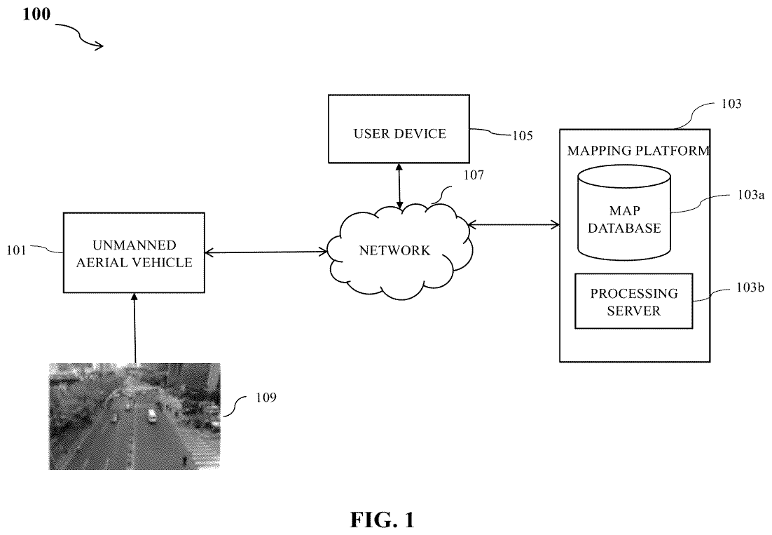

FIG. 1 illustrates a schematic diagram of a network environment 100 of an unmanned aerial vehicle 101 for real-time asset mapping using unmanned aerial vehicles, in accordance with an example embodiment. The unmanned aerial vehicle 101 may be communicatively coupled to a mapping platform 103 via a network 107. The components described in the network environment 100 may be further broken down into more than one component such as one or more sensors or applications in user equipment and/or combined in any suitable arrangement. Further, it is possible that one or more components may be rearranged, changed, added, and/or removed without deviating from the scope of the present disclosure.

In an example embodiment, the unmanned aerial vehicle 101 may be embodied in one or more of several ways as per the required implementation. For example, the unmanned aerial vehicle 101 refers to an aircraft that may be independent of a human pilot onboard. The unmanned aerial vehicle 101 may be remotely controlled or operate autonomously through the user device 105. The unmanned aerial vehicle 101 may be utilized for various purposes that may include but are not limited to aerial surveillance, data collection, and the like. The unmanned aerial vehicle 101, being independent of a human pilot on board, may allow the unmanned aerial vehicle 101 to access remote and hazardous environments, perform tasks efficiently, and gather information from aerial perspectives.

In operation, the unmanned aerial vehicle 101 may be configured to control an image sensor to capture an image of a geographical region. In an embodiment, the image sensor may be but is not limited to, a camera sensor, a radar sensor, a Light Detection and Ranging (LIDAR) sensor, and the like. The image captured by the image sensor associated with the unmanned aerial vehicle 101 may be high-resolution images of geographical regions that may be used for creating detailed maps, topographic surveys, and 3D models of geographical terrains.

Further, the unmanned aerial vehicle 101 may be configured to receive one or more navigational commands. The navigational commands may be associated with a user device 105. The user device 105 may control the navigation of the unmanned aerial vehicle 101 towards the geographical region based on the received one or more navigational commands. Further, upon reaching the geographical region the unmanned aerial vehicle 101 may control the image sensor to capture the image of the geographical region based on the determination that the unmanned aerial vehicle 101 may be over the geographical region.

Further, the unmanned aerial vehicle 101 may be configured to detect the first object of a set of objects in the captured image based on a segmentation of the captured image into one or more segments. In an embodiment, the image of a geographical region that may be captured by the image sensor of the unmanned aerial vehicle 101 may be segmented into one or more segments based on the number of available cores present in the processor of the unmanned aerial vehicle 101. Further, each of the one or more cores of the processor may process each of the one or more corresponding segments of the captured image and perform an object detection process to detect the first object of a set of objects in the captured image.

Further, the unmanned aerial vehicle 101 may be configured to generate an association between the detected first object and the captured image. In an embodiment, upon detection of the first object of the set of objects in the captured image by the unmanned aerial vehicle 101, the unmanned aerial vehicle 101 may generate the association between the detected first object and the captured image based on the application of a lightweight ML model on the detected first object and the captured image. The association may be referred to as establishing an intelligent link by analyzing features from the captured image to recognize and identify detected objects. This may enable real-time decision-making.

Further, the unmanned aerial vehicle 101 may be configured to transmit the generated association to a map database 103a. In an embodiment, upon the generation of association between the detected first object and the captured image, the unmanned aerial vehicle 101 may transmit the generated association to the map database 103a. The unmanned aerial vehicle 101 may transmit the generated association to a centralized map database 103a. The map database 103a may store geographical information, object classifications, and other relevant data tied to a specific location. The transmission of the generated association between the detected first object and the captured image to the map database 103a may enhance the efficiency of data management, allowing real-time updates and centralized access to valuable information derived from unmanned aerial vehicle 101 observations and analysis.

Further, the unmanned aerial vehicle 101 may detect a network event indicative of a disruption in a network connection of the unmanned aerial vehicle 101 with the map database 103a and store the generated association in the memory based on the detection of the network event. For example, during the processing of the captured image, the network may face a disruption in the connection of unmanned aerial vehicle 101 with the map database. In this case, the unmanned aerial vehicle 101 may store the processed image and the generated association between the detected first object and the captured image in the memory of the unmanned aerial vehicle 101. Further, once the connection may have been re-established the unmanned aerial vehicle 101 may transmit the generated association to the map database 103a.

The mapping platform 103 may comprise a map database 103a for storing map data and a processing server 103b. The map database 103a may store node data, road segment data, link data, point of interest (POI) data, link identification information, heading value records, data about various geographic zones, and regions, pedestrian data for different regions, heat maps, or the like. Also, the map database 103a further includes speed limit data of different lanes, cartographic data, routing data, and/or maneuvering data. Additionally, the map database 103a may be updated dynamically to cumulate real-time traffic data. The real-time traffic data may be collected by analyzing the location transmitted to the mapping platform 103 by a large number of road users through the respective user devices of the road users. In one example, by calculating the speed of the road users along a length of the road, the mapping platform 103 may generate a live traffic map, which is stored in the map database 103a in the form of real-time traffic conditions. In an embodiment, the map database 103a may store data of different zones in a region. In one embodiment, the map database 103a may further store historical traffic data that includes travel times, average speeds and probe counts on each road or area at any given time of the day and any day of the year. In an embodiment, the map database 103a may store the probe data over a period of time for a vehicle to be at a link or road at a specific time. The probe data may be collected by one or more devices in the vehicle such as one or more sensors or image capturing devices or mobile devices. In an embodiment, the probe data may also be captured from connected-car sensors, smartphones, personal navigation devices, fixed road sensors, smart-enabled commercial vehicles, and expert monitors observing accidents and construction. In an embodiment, the map data in the map database 103a may be in the form of map tiles. Each map tile may denote a map tile area comprising a plurality of road segments or links. According to some example embodiments, the road segment data records may be links or segments representing roads, streets, or paths, as may be used in calculating a route or recorded route information for the determination of one or more personalized routes. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link and nodes can be associated with attributes, such as geographic coordinates, street names, address ranges, speed limits, turn restrictions at intersections, and other navigation-related attributes. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions, etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

As mentioned above, the map database 103a may be a master geographic database, but in alternate embodiments, the map database 103a may be embodied as a client-side map database and may represent a compiled navigation database that may be used in or with end-user equipment such as the user device 105 to provide navigation and/or map-related functions. For example, the map database 103a may be used with the user device 105 to provide an end user with navigation features. In such a case, the map database 103a may be downloaded or stored locally (cached) on the unmanned aerial vehicle 101.

The processing server 103b may comprise processing means, and communication means. For example, the processing means may comprise one or more processors configured to process requests received from the user device 105. The processing means may fetch map data from the map database 103a and transmit the same to the user device. In one or more example embodiments, the mapping platform 103 may periodically communicate with the user device 105 via the processing server 103b to update a local cache of the map data stored on the user device 105. Accordingly, in some example embodiments, the map data may also be stored on the user device 105 and may be updated based on periodic communication with the mapping platform 103.

In some example embodiments, the user device 105 may be any user-accessible device such as a mobile phone, a smartphone, a portable computer, and the like, as a part of another portable/mobile object such as a vehicle. The user device 105 may comprise a processor, a memory, and a communication interface. The processor, the memory, and the communication interface may be communicatively coupled to each other. In some example embodiments, the user device 105 may be associated, coupled, or otherwise integrated with a vehicle of the user, such as an advanced driver assistance system (ADAS), a personal navigation device (PND), a portable navigation device, an infotainment system and/or another device that may be configured to provide route guidance and navigation-related functions to the user. In such example embodiments, the user device 105 may comprise processing means such as a central processing unit (CPU), storage means such as on-board read-only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user device 105. Additional, different, or fewer components may be provided. In one embodiment, the user device 105 may be directly coupled to the system 101 via the network 107. For example, the user device 105 may be a dedicated vehicle (or a part thereof) for gathering data for the development of the map data in the database 103a. In some example embodiments, the user device 105 may serve the dual purpose of a data gatherer and a beneficiary device. The user device 105 may be configured to capture sensor data associated with a road that the user device 105 may be traversing. The sensor data may for example be images of road objects, road signs, or the surroundings. The sensor data may refer to sensor data collected from a sensor unit in the user device 105. In accordance with an embodiment, the sensor data may refer to the data captured by the vehicle using sensors. The user device 105 may be communicatively coupled to the unmanned aerial vehicle 101, over the network 107.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example embodiment, the system may be integrated with the user device 105. For example, the mapping platform 103 may be integrated into a single platform to provide a suite of mapping and navigation-related applications for OEM devices, such as the user devices and the unmanned aerial vehicle 101. The unmanned aerial vehicle 101 may be configured to communicate with the mapping platform 103 over the network 107.

Geographical image 109 may be the image captured by the image sensor associated with or integrated within the unmanned aerial vehicle 101. The geographical image 109 may be a high-resolution image of a geographical region (say an urban city) that may help in city planning by mapping infrastructure, roads, and building layouts. Further, the geographical image 109 may be an image related to agricultural regions, and environmental images that may help in monitoring deforestation, wildlife habitats, and the like.

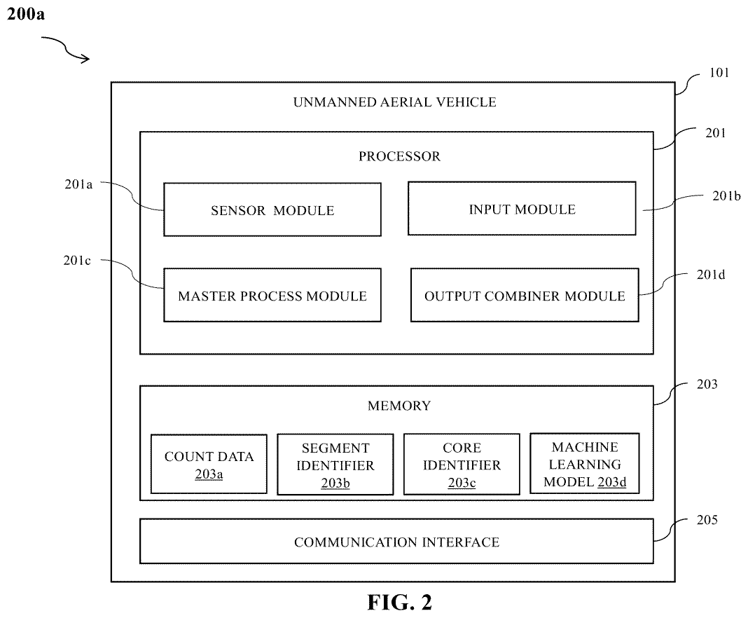

FIG. 2 illustrates a block diagram 200a of the unmanned aerial vehicle 101 for real-time asset mapping with an example embodiment. The unmanned aerial vehicle 101 may include at least one processor 201 (hereinafter, also referred to as “processor 201”), at least one memory 203 (hereinafter, also referred to as “memory 203”), and at least one communication interface 205 (hereinafter, also referred to as “communication interface 205”). The processor 201 may include a sensor module 201a, an input module 201b, a master process module 201c, and an output combiner module 201d. The processor 201 may retrieve computer program code instructions that may be stored in the memory 203 for execution of the computer program code instructions. The memory 203 may include count data 203a, a segment identifier 203b, and a core identifier 203c. Additionally or alternatively, the memory 203 may store a machine learning (ML) model 203d.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining, and/or multithreading.

Additionally, or alternatively, the processor 201 may include one or more processors capable of processing large volumes of workloads and operations to provide support for big data analysis. In an example embodiment, processor 201 may be in communication with the memory 203 via a bus for passing information among components coupled to the unmanned aerial vehicle 101.

The sensor module 201a may be configured to receive data from one or more sensors including but not limited to acoustic sensors such as the image sensor such as a camera and the like. Different sensors equipped in a vehicle can be used for perception and localization detection which are two of the fundamental technologies in autonomous driving. A radar sensor is used to detect the object's distance, velocity, and range, by sending radio waves. The LIDAR sensor is used to determine the object's distance by creating the 3D rendering images of the autonomous driving vehicle's surroundings by spinning a laser emitting millions of light pulses per second to view and measure each point the laser scanned. For example, the one or more sensors include a camera. The camera may be used to capture an image associated with one or more objects in the environment of the unmanned aerial vehicle 101.

In an embodiment, an unmanned aerial vehicle (UAV) (equivalently referred to as a “drone”), may have an image sensor that is configured to capture the image of objects detected by the UAV during a flight.

In an embodiment, the image is using a CNN (Convolutional Neural Network) and DNN (Deep Neural Network) machine learning image technologies. Satellite systems like GPS, GLONASS, and BEIDOU, together with Wi-Fi, Bluetooth, and inertial sensors like Gyro Accelerometer, and HD-MAP are used to help autonomous vehicles determine their precise location. V2X sensors (4G/5G modem) help exchange information including real-time traffic, road hazards, weather, and parking between the autonomous driving vehicle and back-end infrastructure.

To that end, the sensor module 201a may be configured to acquire sensor data and vehicle data from the unmanned aerial vehicle 101. The sensor data may be associated with a region including a plurality of roads. The region is a bounding region and is defined by making a polygon around the region in a map display. In one embodiment, the sensor data and the vehicle data are obtained from a connected vehicle during a drive. The sensor module 201a is configured to receive dynamic data from a server based on the reception of the sensor data. Dynamic data may include weather data, traffic data, incident data, map data, hazard warning data, traffic pattern data, and the like. The sensor data indicates at least one of the driving conditions of the vehicle in the region or a surrounding environmental condition of the vehicle. The sensor data may include all the sensors equipped to detect the vehicle's driving conditions or its surrounding driving environments like road signs, road conditions, and the like.

The input module 201b may be configured to receive data acquired by the sensor module 201a and manage the received data for further processing by the processor 201. The data acquired by the sensor module 201a may correspond to the image captured by the image sensor associated with the unmanned aerial vehicle 101. The input module 201b may receive the image and feed it to the master process module 201c for further processing. For example, the image may be the geographical image 109.

In an embodiment, the input module 201b may receive drone captured imagery. The drone captured imagery may offer an aerial perspective of landscapes, roads, and infrastructure that may provide a broader context for image processing. The input module 201b may also receive predefined datasets that may be related to road scenarios.

The master process module 201c may be configured to segment the image that may be received from the input module 201b into one or more segments based on the number of cores present in the processor 201 of the unmanned aerial vehicle 101. The processor 201 of the unmanned aerial vehicle 101 may further use the master process module 201c to allocate each of the one or more segments of the image to the corresponding core of one or more cores of the processor 201 of the unmanned aerial vehicle 101.

In an exemplary embodiment, the image may be received from the input module 201b. In order to segment the image into one or more segments, the processor 201 of the unmanned aerial vehicle 101 may determine the number of cores that may be available in the processor 201. Upon the determination of the number of cores that may be present in the processor 201 of the unmanned aerial vehicle 101, the processor 201 may use the master process module 201c to segment the image based on the determined number of cores. The processor 201 of the unmanned aerial vehicle 101 may further use the master process module 201c to allocate each of the one or more segments of the captured image to the corresponding core of one or more cores of the processor 201 of the unmanned aerial vehicle.

The output combiner module 201d may be configured to combine each of the processed one or more segments of the image to form a combined processed image.

In an exemplary embodiment, the processor 201 associated with the unmanned aerial vehicle 101 may include the output combiner module 201d. The output combiner module 201d may receive the processed one or more segments of the image that may be processed in the one or more cores of the processor 201 associated with the unmanned aerial vehicle 101. The output combiner module 201d may combine each of the processed segments of the image and output the combined processed image. The processor 201 associated with the unmanned aerial vehicle 101 may generate navigation instructions based on the combined processed image.

The memory 203 may be non-transitory and may include, for example, one or more volatile and/or non-volatile memories. In other words, for example, the memory 203 may be an electronic storage device (for example, a computer-readable storage medium) comprising gates configured to store data (for example, bits) that may be retrievable by a machine (for example, a computing device like the processor 201). The memory 203 may be configured to store information, data, content, applications, instructions, or the like, to enable the apparatus to conduct various functions in accordance with an example embodiment of the present invention. For example, the memory 203 may be configured to buffer input data for processing by the processor 201.

As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA, or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor-specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU), and logic gates configured to support operation of the processor 201.

The count data 203a stored in the memory 203 may store the number of cores present in the processor 201 of the unmanned aerial vehicle 101. The core within a processor 201 may be an independent processing unit. Each core may be capable of executing its own set of instructions, allowing the processor 201 of the unmanned aerial vehicle 101 to handle multiple tasks simultaneously. There may be multi-core processors, for example, dual-core processors, and quad-core processors, and there may be multiple cores working in parallel that may significantly improve the overall performance and efficiency of the processor 201 of the unmanned aerial vehicle 101.

In an exemplary embodiment, the processor of the unmanned aerial vehicle 101 is a quad-core processor, the count data 203a stored in the memory 203 may be four as there are four cores in the quad-core processor. In another exemplary embodiment, the processor of the user device 105 is a dual-core processor, the count data 203a stored in the memory 203 may be two as there are two cores in the dual-core processor.

In another exemplary embodiment, the processor 201 of the unmanned aerial vehicle 101 may determine the count data based on the available number of cores of the processor 201. For example, based on one of the four cores of a quad-core processor

The segment identifier 203b stored in the memory 203 may be the segment ID given to each segment of the captured image. The processor 201 associated with the UAV 101 may segment the image based on the count data 203a.

In an exemplary embodiment, the processor 201 of the unmanned aerial vehicle 101 being a quad-core processor, the processor 201 may utilize the count data 203a to efficiently segment the captured image using the master process module 201c. Segmenting the image may correspond to dividing the captured image into four distinct quadrants based on the count data 203a being four. Each segment of the image may correspond to the core within the processor 201 of the unmanned aerial vehicle 101. To manage and identify the segments, a unique segment-ID may be assigned to each segment. For example, the first quadrant of the captured image may be associated with segment-ID 1, the second quadrant of the captured image may be associated with segment-ID 2, the third quadrant of the captured image may be associated with segment ID 3 and the fourth quadrant of the captured image may be associated with segment-ID 4.

The core identifier 203c stored in the memory 203 may be a unique core-ID that may be associated with each of the one or more cores of the processor 201 associated with the unmanned aerial vehicle 101.

In an exemplary embodiment, the processor 201 of the unmanned aerial vehicle 101 is a quad-core processor, the first core of the processor of the unmanned aerial vehicle 101 may be associated with the core-ID 1, the second core of the processor 201 of the unmanned aerial vehicle 101 may be associated with the core-ID 2, the third core of the processor 201 of the unmanned aerial vehicle 101 may be associated with the core-ID 3 and the fourth core of the processor 201 of the unmanned aerial vehicle 101 may be associated with the core-ID 4.

The machine learning model 203d stored in the memory may be a CNN based model that may be initially trained on a dataset specially for application domain such as but not limited to object detection. During training the machine learning model 203d may learn to recognize and interpret features within the image, enabling it to perform tasks such as but not limited to object detection, object recognition, and classification. The streamlined and optimized machine learning model 203d may be integrated into a multi-threaded architecture that may be designed to use parallel processing capabilities across all the available cores of the processor of the unmanned aerial vehicle 101. The integration may ensure that the machine learning model 203d efficiently processes all the segments of the captured image.

In an embodiment, the processor 201 of the unmanned aerial vehicle 101 may be configured to apply a first machine learning model on the one or more segments of the captured image. The captured image may be the geographical image 109. The first ML model may be trained using a training data set. Further, the processor 201 of the unmanned aerial vehicle 101 may be configured to retrieve the training dataset associated with object detection for training the first ML model. The processor 201 may further train the first ML model based on the retrieved training dataset.

Further, the processor 201 of the unmanned aerial vehicle 101 may detect the first object in the captured image based on the application of the first ML model on one or more segments of the captured image. The processor 201 may further apply a second ML model on the detected first object and the captured image to generate an association between the detected first object and the captured image.

In an exemplary embodiment, the first ML model and the second ML model may be applied on each of one or more cores of the processor 201 of the unmanned aerial vehicle 101 as each of the one or more cores of the processor 201 corresponds to each of one or more segments of the captured image.

In an embodiment, the machine learning model 203d is optimized using a TensorRT™ engine. TensorRT™ is a high-performance deep learning inference optimizer and runtime library developed by NVIDIA™. It's designed to optimize and deploy trained neural network models for inference. TensorRT™ takes trained neural networks, optimizes them for runtime efficiency, and generates runtime engines that deliver low-latency, high-throughput inference for various applications, including image classification, object detection, natural language processing, and more.

In an embodiment, the TensorRT™ engine generates an optimized ONNX, or Open Neural Network Exchange model. ONNX is a universal and open-source format designed to facilitate the transfer of trained neural network models across diverse deep-learning frameworks. This interoperable standard allows seamless exchange and deployment of machine learning models, enabling compatibility and collaboration between different AI platforms. By utilizing ONNX, developers can convert, optimize, and deploy models across a wide range of environments, fostering innovation and accelerating the development and deployment of AI applications.

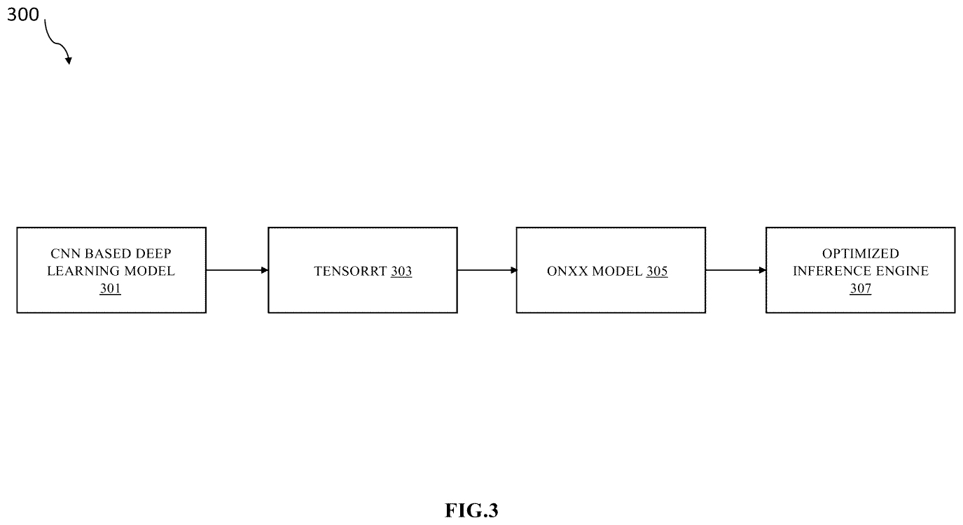

In an embodiment, the generated ONNX model is used by an inference engine which will run on different cores of the processor of the UAV 101 for processing different parts of the image. The inference engine uses a multi-threaded architecture that may be designed to use parallel processing capabilities across all the available cores of the processor of the unmanned aerial vehicle 101. The integration may ensure that the machine learning model 203d efficiently processes all the segments of the image in parallel, speeding up inference deduction. The generation of the ONNX model is further explained in FIG. 3.

The communication interface 205 may comprise the input interface and output interface for supporting communications to and from the user device 105 or any other component with which the unmanned aerial vehicle 101 may communicate. The communication interface 205 may be any means such as a device or circuitry embodied in either hardware or a combination of hardware and software that is configured to receive and/or transmit data to/from a communications device in communication with the user device 105. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to manage receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB), or other mechanisms for enabling the UAV 101 to conduct information exchange functions in many different forms of communication environments. The communication interface enables the exchange of information and instructions for detecting road zones and updating it on map data stored in the map database 103a.

FIG. 3 shows a block diagram that depicts a method for generating an optimized model, such as an ONNX model 305, to be used in real-time asset mapping using unmanned aerial vehicles, in accordance with an embodiment of the present disclosure. FIG. 3 may include a CNN based deep learning model 301, a TensorRT™ engine 303, the ONNX model 305, and an optimized inference engine 307.

The CNN based deep learning model 301 may represent a program that can be pre-trained on a specific dataset for a particular application using a framework and perform a computer vision task. The CNN based deep learning model 301 may be used in an inference engine to perform the computer vision task. The computer vision task includes different tasks on the images and videos, such as finding and labeling objects, dividing the image into regions, or other tasks that require the understanding of the image content. The CNN based deep learning model 301 may consist of convolution blocks, activation functions, pooling layers, regularization, linear layer, and normalization layers. The convolution blocks may utilize convolutional layers to detect features like edges and textures in the input image. The activation function may introduce non-linearity. The non-linearity may allow the CNN based deep learning model 301 to learn complex relationships in the image. Further, the pooling layers may reduce the spatial dimensions. Upon removing the special dimensions, the CNN based deep learning model 301 may focus on notable features while decreasing computational load. The CNN based deep learning model 301 is pre-trained and provided to the TensorRT™ engine 303 for optimization.

The TensorRT™ engine 303 comprises a high-performance deep learning inference library developed that includes instructions to optimize and deploy the pre-trained CNN based deep learning model 301 to run with higher throughput and lower latency.

In an embodiment, the unmanned aerial vehicle 101 may incorporate the capabilities of the TensorRT™ engine 303. The process of optimization of CNN based deep learning model 301 may commence with the utilization of lightweight CNN models, pre-trained on application-specific datasets. Then the TensorRT™ engine 303 may function as an optimization engine and may dynamically refine the CNN based deep learning model 301 into highly streamlined variants, enhancing their efficiency for deployment. The result may be the generation of the optimized ONNX model 305.

The ONNX model 305 may serve as a versatile translator. The ONNX model 305 may make the CNN based deep learning model 301 communicate with different types of processors or CPUs. The versatility of the ONNX model 305 may make the CNN based deep learning model 301 universally compatible, allowing it to work seamlessly across various computing setups.

The ONNX model 305 is further processed by the optimized inference engine 307. The optimized inference engine 307 may be a runtime engine that may be suitable for the deployment environment. The optimized inference engine 307 may efficiently execute the inference tasks based on the ONNX model 305. The optimized inference engine 307 may process the image that may be received by the input module 201b from the sensor module 201a.

In an embodiment, the ONNX model 305 may be passed on to the optimized inference engine 307. The ONNX model 305 which may function as a universal interface may be converted to seamlessly blend with the optimized inference engine 307. The conversion may ensure that it efficiently translates high-level instructions into a format that may maximize the speed of processing while maintaining accuracy. The optimized inference engine 307 which may contain the optimized CNN-based deep learning model 301 may become a high-performance tool for managing the image from various sources. The image is processed using the optimized inference engine 307 which is based on inference deduction by segmenting the image into one or more segments.

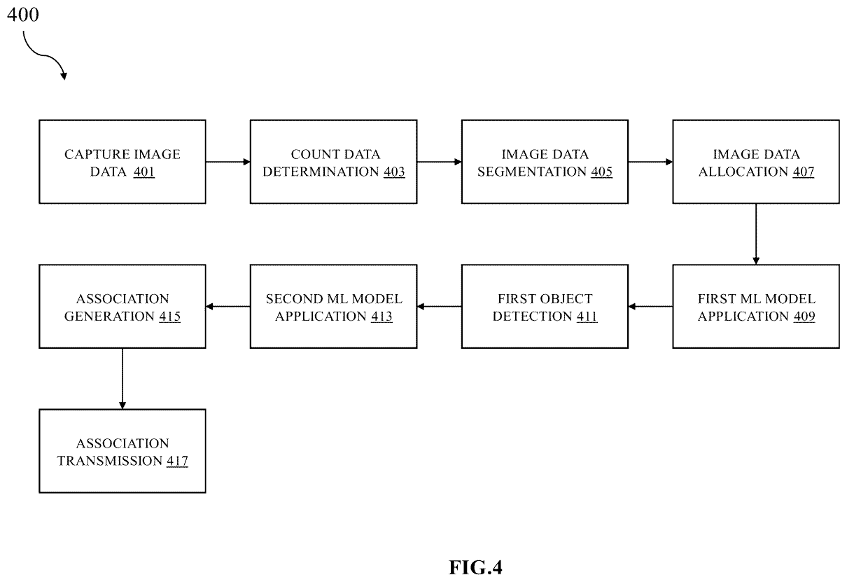

FIG. 4 illustrates is a diagram that illustrates exemplary operations for real-time asset mapping using unmanned aerial vehicles, in accordance with an embodiment of the disclosure. With reference to FIG. 4, there is shown a block diagram 400 that illustrates exemplary operations from 401 to 417, as described herein. The exemplary operations illustrated in the block diagram 400 may start at 401 and may be performed by the unmanned aerial vehicle 101 of FIG. 2.

At 401, an image-capturing operation is performed. In the image-capturing operation, the processor 201 may be configured to receive one or more navigational commands associated with the navigation of the unmanned aerial vehicle 101 from a user device 105. Further, the processor 201 may be configured to control the navigation of the unmanned aerial vehicle 101 towards the geographical region based on the received one or more navigational commands. The processor 201 may further control the image sensor to capture the image of the geographical region based on a determination that the unmanned aerial vehicle 101 may be over the geographical region.

At 403, a count data determination operation may be performed. The count data determination operation may include a determination that all the four cores of the processor 201 may be available for processing. Further, based on the determination that the processor 201 may be a quad core processor, the processor 201 may be configured to determine the count of number of available cores as four. The processor, based on a number of pre-occupied core, determine the count data to indicate a number of available cores. For example, based on the determination that one of the four cores may be pre-occupied with a processing task, the count data determination operation may determine the count data as three.

At 405, an image segmentation operation may be performed. The image segmentation operation may include segmenting, using the master process, the captured image into one or more segments based on the determined count data. For example, the determined count data being four, the processor 201 may be configured to segment the captured image into four segments. In another example, based on the determined count data being three, the processor 201 may segment the captured image data into three segments.

At 407, an image allocation operation may be performed. The image allocation operation may include allocating, using the master process, the one or more segments of the captured image to one or more cores of the processor 201 of the unmanned aerial vehicle 101. For example, based on the determined count data being four, the processor 201 of the unmanned aerial vehicle 101 may allocate, using the master process, the four segments of the captured image to the four cores of the processor 201. The each of one or more segments of the captured image is associated with a segment identifier and each of the one or more cores of the processor 201 of the unmanned aerial vehicle 101 is associated with a core identifier.

At 409, a first ML model application operation may be performed. The first ML model application operation may include applying the first ML model on the one or more segments of the captured image. The ML model may be trained using a training dataset. The first ML model may be pre-trained on a specific dataset for a particular application and then it may be deployed on the one or more cores of the processor 201 of the unmanned aerial vehicle 101.

At 411, a first object detection operation may be performed. The first object detection operation may include detecting the first object in the captured image based on the application of the first ML model on the one or more segments of the captured image. For example, the captured image may be segmented into one or more segments based on the number of available cores of the processor 201, first ML model may be applied on each of the one or more segments present in each of one or more available cores of the processor 201. The first ML model may help detect the first object in the captured image.

At 413, a second ML model application operation may be performed. The second ML model application operation may include allocation of the second ML model on the detected first object and the captured image. Further, the processor 201 of the unmanned aerial vehicle 101 may be configured to generate the association between the detected first object and the captured image based on the application of the second ML model on the detected first object and the captured image. For example, based on the captured image being a read image, the first ML model may detect pedestrians, cars, and lane markings in the captured image. Further, the second ML model may be deployed on each of the detected objects and the captured image to generate an association between the detected first object and the captured image.

At 415, an association generation operation may be performed. The association generation operation may include identifying the detected first object and associating it with the captured image. For example, once the first object has been detected on one segment of the captured image, the processor 201 may apply a second ML model to generate an association of where the detected first object lies on the captured image. The generated association may be stored in the map database 103a in real-time.

At 417, an association transmission operation may be performed. The association transmission operation may include transmitting the generated association between the detected object and the captured image to the map database 103a. The transmission of the generated association may take place over the network 107. In an embodiment, based on the processor 201 of the unmanned aerial vehicle 101 detecting a network event that may be indicative of a disruption in a network connection of the unmanned aerial vehicle 101 with the map database 103a, the processor 201 may store the generated association in the memory of the unmanned aerial vehicle and transmit the generated association once the connection is re-established. Further, the processor 201 of the unmanned aerial vehicle may control the location sensor to capture location information associated with the geographical region and transmit the captured location information to the map database 103a.

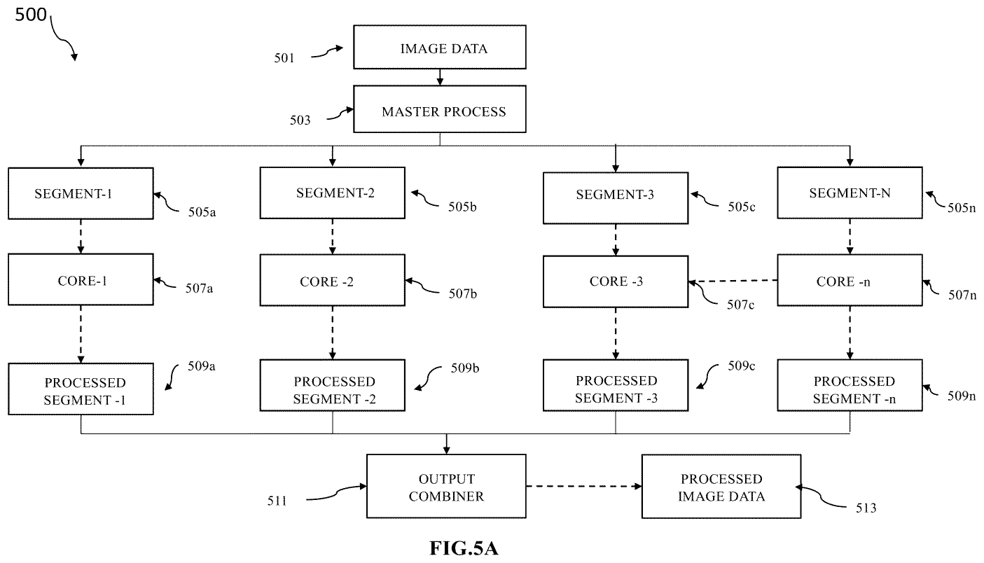

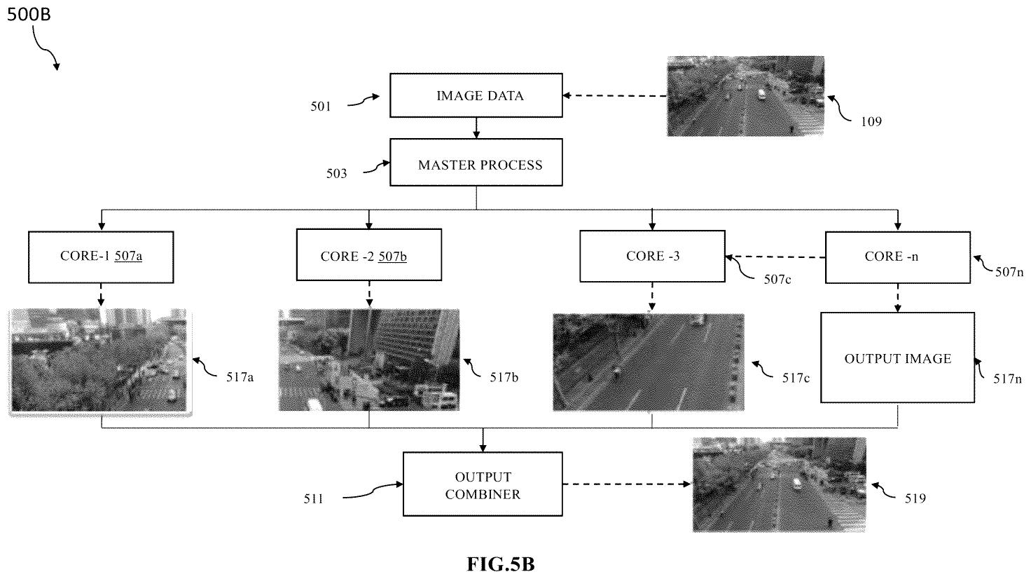

FIG. 5A illustrates a block diagram of a method for segmenting image 501, in accordance with an embodiment of the present disclosure. FIG. 5A may include an image 501, a master process 503, a segment-1 505a, a segment-2 505b, a segment-3 505c, up to segment-n 505n. FIG. 5A may further include a core-1 507a, a core-2 507b, a core-3 507c up to core-n 507n. Further FIG. 5A may include a processed segment-1 509a, a processed segment-2 509b, a processed segment-3 509c, up to a processed segment-n 509n. FIG. 5A may further include an output combiner 511 and a processed image 513.

In an embodiment, the processor 201 may obtain the image 501. The image 501 may be obtained by using the image sensor. The image sensor may be associated with the unmanned aerial vehicle 101. The image 501 may be obtained from diverse data sources including but not limited to drone-captured imagery and a Global Positioning System (GPS) sensor. For example, an image of a geographical region.

The image 501 is transmitted to the master process 503 which is a control unit or a main algorithm responsible for coordinating and overseeing the entire image processing pipeline for the image 501. The master process 503 may be configured to orchestrate various tasks, algorithms, or modules involved in the image processing pipeline to achieve a specific goal.

In one embodiment, the goal is to segment the image 501 into one or more segments based on the count data. Thus, the master process 503 manages the flow of data and operations between distinct stages or modules of the unmanned aerial vehicle 101. For example, the master process 503 may obtain the count data 203a from the memory 203 and segments the image 501 into as many number of segments as indicated by the count data 203a. To that end, the count data 203a may be the total number of cores present in the processor of the unmanned aerial vehicle 101. Further, the master process 503 is configured to allocate the one or more segments of the image 501 to a corresponding core of the one or more cores of the processor of the unmanned aerial vehicle 101.

As illustrated in FIG. 5A, the master process 503 is configured to segment the image 501 into ‘n’ segments like the segment-1 505a, the segment-2 505b, the segment-3 505c, up to the segment-n 505n. The number of segments of the image 501 may be based on the count data 203a. To that end, ‘n’ may be a numerical value indicating the number of available cores of the processor of the unmanned aerial vehicle 101. As may be understood by one of ordinary skill in the art, a core of a processor is a component of the processor that is responsible for executing instructions and performing calculations. A processor may include one or more cores, each capable of executing instructions independently. Further, each core comprises its own execution units such as arithmetic logic units (ALUs), floating point units (FPUs), and control units. As a result, each core can independently perform arithmetic, logical, and control operations. Some cores support multithreading, which allows them to manage multiple instruction streams concurrently, further improving efficiency by optimizing resource usage.

For example, when the processor of the unmanned aerial vehicle 101 is a quad core processor, the number of cores is four, and hence the count data is four. The master process 503 may segment the image 501 into four segments, each segment corresponding to a quadrant of the image represented by the image 501. Each of the four quadrants is associated with a unique segment identifier 203b. The unique segment identifier 203b may be equivalent to the unique segment identifier 203b explained in the FIG. 2.

Further, the master process 503 is configured to allocate the segments of the image 501 such as (the segment-1 505a, the segment-2 505b, segment-3 505c up to segment-n 505n) to the corresponding core of the one or more cores of the processor of the unmanned aerial vehicle 101. The corresponding core of the one or more cores of the processor of the unmanned aerial vehicle 101 may be associated with the core identifier 203c. The core identifier 203c may be equivalent to the core identifier 203c explained in the FIG. 2.

In an exemplary embodiment, master process 503 may allocate—the segment-1 505a to the corresponding core-1 507a, the segment-2 505b to the core-2 507b, the segment-3 505c to the core-3 507c up to the segment-n 505n to the core-n 507n.

Further, each of the cores then processes each of the one or more segments in parallel, thereby increasing the overall processing efficiency of the image processing pipeline. The processing of the image 501 may be done to accomplish a goal such as object detection, image classification, asset mapping, anomaly detection, identifying features like lane markings, assessing traffic conditions, and the like.

Further, after the processing of each of one or more segments of the image 501 in the corresponding core of the one or more cores of the processor of the unmanned aerial vehicle 101, the one or more cores may output the processed segments such as the processed segment-1 509a, the processed segment-2 509b, the processed segment-3 509c up to the processed segment-n 509n. For example, the segment-1 505a of the image 501 that may be processed in the core-1 507a of the processor of the unmanned aerial vehicle 101 may output the processed segment-1 509a. The segment-2 505b that may be processed in the core-2 507b of the processor of the unmanned aerial vehicle 101 may output the processed segment-2 509b. The same process may be followed for the segment-3 505c up to the segment-n 505n.

Once all the segments are processed, the processor of the unmanned aerial vehicle 101 may be configured to control the output combiner 511. The output combiner 511 may combine each of the one or more processed segments of the image 501 to form combined processed image 513. The one or more processed segments comprise—the processed segment-1 509a, the processed segment-2 509b, the processed segment-3 509c, and the processed segment-n 509n (hereinafter the one or more processed segments are referred to as the processed segments 409a-409n for the sake of brevity of disclosure).

In an example, the master process 503 may be configured to control the output combiner 511 to combine each of the processed segments 509a-509n. Thus, the output combiner 511 may integrate the processed segments from all the one or more cores of the processor 201 of the unmanned aerial vehicle 101. In an example the integration of the processed segments includes an image stitching operation. In other implementations other equivalent image segment combining algorithms may be used without deviating from the scope of the present disclosure. The combined processed image 513 may represent comprehensive analysis of the entire image 501, benefiting from the parallelized approach that may accelerate the overall computational efficiency and may enhance the speed of image processing tasks.

In an exemplary embodiment, the processed image 513 is a processed image of a road, object detection, classification, and computer vision tasks may be performed efficiently. The processed image 513 may be enhanced, with details extracted from distinct parts of the road. The processed image 513 may be further used for applications such as but not limited to navigational instructions or storage in map databases.

In some embodiments, each segment of the image 501 may further be sub-segmented so as to leverage multiple sub-cores within each core of the processor 201 of the unmanned aerial vehicle 101, thereby further improving parallelization capability and efficiency of the unmanned aerial vehicle 101 for performing any image processing task.

FIG. 5B illustrates a block diagram for segmenting image 501, in accordance with an embodiment of the present disclosure. FIG. 5B may include image 501, master process 503, core-1 507a, core-2 507b, core-3 507c up to core-n 507n. FIG. 5B may further include processed segmented image (517a up-517n) of the image 501.

In an embodiment, the processor 201 of the unmanned aerial vehicle 101 may control an image sensor to capture the image 515 of the geographical region. The unmanned aerial vehicle 101 may receive one or more commands associated with the navigation of the unmanned aerial vehicle from the user device 105. The user device 105 may receive inputs from the user and may translate the inputs as navigational commands to the unmanned aerial vehicle 101. The processor 201 of the unmanned aerial vehicle 101 may control the navigation of the unmanned aerial vehicle towards the region based on the received one or more navigational commands. Further, the processor 201 of the unmanned aerial vehicle 101 may control the image sensor to capture the image of the geographical region based on a determination that the UAV is over the geographical region.

Further, the captured image of the geographical region may be received by the processor 201 as image 501. The processor 201 may determine the count data associated with one or more cores of the processor 201 of the unmanned aerial vehicle 101. For example, based on the determination that processor 201 may be a quad-core processor and based on the determination that each of the four cores of the processor 201 is available for processing, the determined count data 203a may be four.

In an embodiment, the master process 503 may allocate segments of the image 501 to each of the core of the processor 201. Further, the each of the one or more cores of the processor 201 may process the corresponding segments. Upon the processing of each of the one or more segments of the image 501, each of the one or more cores of the processor 201 may output the processed segments (509a-509n). The processed segments (509a-509n) may correspond to images such as 517a-517n as shown in the FIG. 5B.

In an embodiment, based on the application of the first ML model in each of one or more cores of the processor 201 the first object of the set of objects may be detected in the segments of the image.

In an exemplary embodiment, the first object may be detected in the image segment. The first object may be detected by using the first ML model. The first ML model may be applied on each of one or more cores of the processor 201. The same process for image detection may be followed for image segments 517b, 517c up to 517n.

The output combiner 511 may receive all the processed image segments and collate them to form the captured image. The second ML model may be applied to the image to generate the association between the detected objects and the captured image. Further, the generated association may be stored in the map database 103a.

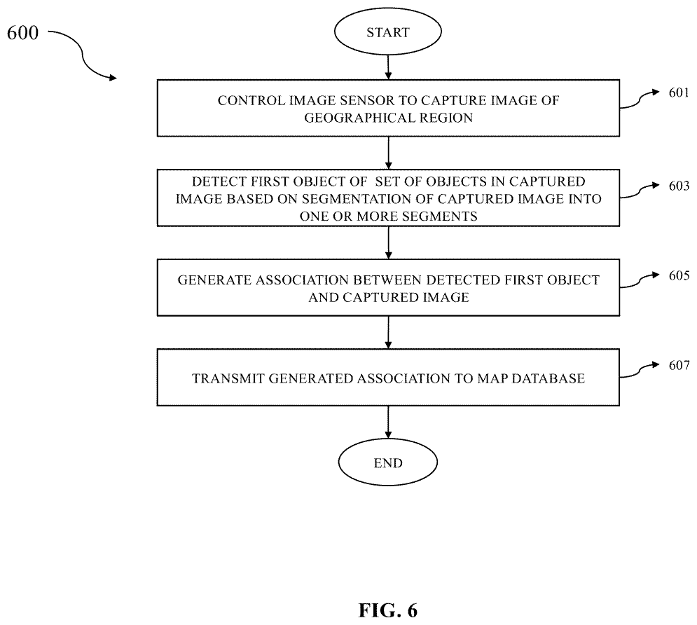

FIG. 6 illustrates a flow diagram of a method real-time asset mapping using unmanned aerial vehicle 101, in accordance with an example embodiment. It will be understood that each block of the flow diagram of the method 600 may be implemented by various means, such as hardware, firmware, processor, circuitry, and/or other communication devices associated with the execution of software including one or more computer program instructions. For example, one or more of the procedures described above may be embodied by computer program instructions. In this regard, the computer program instructions that embody the procedures described above may be stored by a memory 203 of the unmanned aerial vehicle 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special-purpose hardware-based computer systems that perform the specified functions, or combinations of special-purpose hardware and computer instructions.

At 601, method 600 comprises instructions to control the image sensor to capture an image of a geographical region. In an embodiment, the processor 201 may be configured to control the image sensor to capture the image of the geographical region.

At 603, the method 600 comprises instructions to detect the first object of a set of objects in the captured image based on the segmentation of the captured image into one or more segments. In an embodiment, the processor 201 may be configured to detect the first object of a set of objects in the captured image based on the segmentation of the captured image into one or more segments.

At 605, the method 600 comprises instructions to generate an association between the detected first object and the captured image. In an embodiment, the processor 201 may be configured to generate an association between the detected first object and the captured image.

At 607, the method 600 comprises instructions to transmit the generated association to the map database. In an embodiment, the processor 201 may be configured to transmit generated association to the map database.

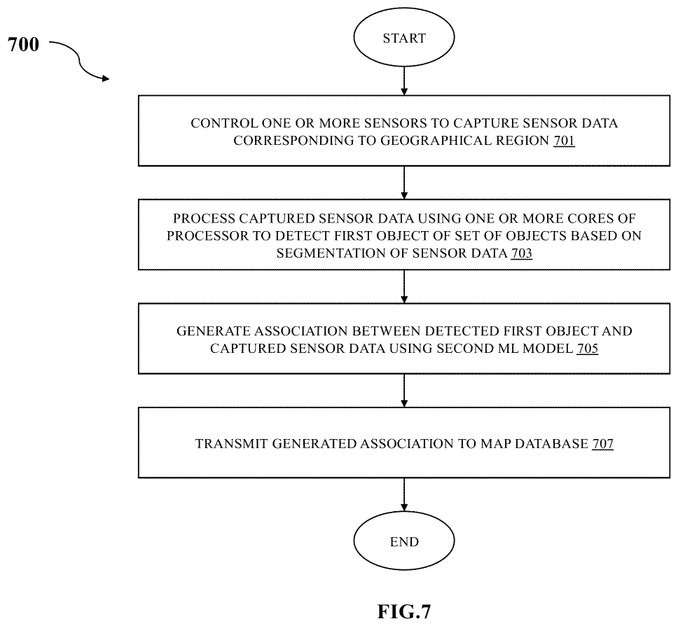

FIG. 7 illustrates a flow diagram of a method of real-time asset mapping using unmanned aerial vehicle 101, in accordance with an example embodiment. It will be understood that each block of the flow diagram of the method 700 may be implemented by various means, such as hardware, firmware, processor, circuitry, and/or other communication devices associated with the execution of software including one or more computer program instructions. For example, one or more of the procedures described above may be embodied by computer program instructions. In this regard, the computer program instructions that embody the procedures described above may be stored by a memory 203 of the unmanned aerial vehicle 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special-purpose hardware-based computer systems that perform the specified functions, or combinations of special-purpose hardware and computer instructions.

Traditionally, AI/ML techniques may be used for the detection of utilities such as high-tension wires. The AI/ML techniques were expensive and required high-performing GPUs and storage for image and video. The AI/ML techniques rely on computer vision techniques and may be very computer intensive and may require a large amount of storage.

In the technique disclosed below, the unmanned aerial vehicle 101 may be integrated with sensors such as a galvanometer sensor, a Hall effect magnetometer sensor, a corona discharge meter sensor, or any other electric field measuring sensor. Based on these sensors, the unmanned aerial vehicle 101 may detect various properties related to electrical conductivity (i.e. the sensor data). The presence of electrical conductivity may be done remotely using the unmanned aerial vehicle 101. The one or more sensors may create an interferogram based on the electrical lines based on an electrical signature, thus any foreign field which may also be recorded by the one or more sensors may be distinguished while mapping. Further, a 3D graph may be obtained having the location and magnetic field presence.

At 701, the method 700 comprises instructions to control one or more sensors to capture sensor data corresponding to geographical regions. In an embodiment, the processor 201 may be configured to control one or more sensors to capture sensor data corresponding to geographical regions. The one or more sensors may correspond to a galvanometer sensor, a Hall effect magnetometer sensor, a corona discharge meter sensor, a non-contact voltage tester sensor, or any other electric field measuring sensor. Each of the one or more sensors may be very cheap and are capable of detecting various properties (i.e. the sensor data) related to electricity such as magnetic fields.

At 703, the method 700 comprises instructions to process captured sensor data using one or more cores of the processor to detect the first object of a set of objects. In an embodiment, the processor 201 may be configured to process captured sensor data using one or more cores of the processor to detect the first object of a set of objects based on the segmentation of the sensor data. In an embodiment, the apparatus that may correspond to the unmanned aerial vehicle 101 may carry one or more sensors and the object to be detected corresponds to electrical wires. The unmanned aerial vehicle 101 may fly over high-tension electrical wires and may generate an interferogram of detected fields. The interferogram may be a visual representation of inference patterns that may result from the combination of two or more coherent waves. The interferogram will help in mapping the conductor lines based on an electrical signature, thus any foreign field that may also be recorded by sensors can be distinguished while mapping.

At 705, the method 700 comprises instructions to generate an association between the detected first object and captured sensor data. In an embodiment, the processor 201 may be configured to generate an association between the detected first object and captured sensor data. In an embodiment. In an embodiment, the electrical and magnetic conductivity may be stronger near the high-tension wires, and the generated association between the captured first object and the captured sensor data may help to avoid collision of unmanned aerial vehicle 101. In an embodiment, lightweight ML models may be used for mapping the distance variation. In some embodiments, the unmanned aerial vehicle 101 may be configured to determine a predetermined strength of data logging corresponding to a predetermined distance, for example, one meter. Further, the predetermined strength of data logging may decrease based on an increase in the predetermined distance between the unmanned aerial vehicle 101 and the high-tension wire. In an example embodiment, the strength may be decreased by a derivative factor (y2−y1)/(x2−x1) based on the predetermined distance between the unmanned aerial vehicle 101 and the high tension wire, for example, 10 meters. Further, the data logging of strength may help in developing an optimal detection range and electrical signatures at various elevation levels for different voltages of high tension wires (HV or EHV), and through this data logging, the unmanned aerial vehicle 101 will be guided if it may get close or further away far from the high tension wire avoiding collision of the unmanned aerial vehicle 101.

At 707, the method 700 comprises instructions to transmit the generated association to the map database. In an embodiment, the processor 201 may be configured to transmit generated association to the map database. The generated association may be initially mapped under supervision at various altitude levels to determine accurate flying height vs presence detected.

Accordingly, blocks of the flowchart 700 support combinations of means for performing the specified functions and combinations of operations for performing the specified functions. It will also be understood that one or more blocks of the flowchart 700, and combinations of blocks in the flowchart 700, can be implemented by special-purpose hardware-based computer systems which perform the specified functions, or combinations of special-purpose hardware and computer instructions.

Alternatively, the unmanned aerial vehicle 101 may comprise means for performing each of the operations described above. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be outlined in some of the appended claims. Although specific terms are employed herein, they are used in a generic and descriptive sense only and not for purposes of limitation.

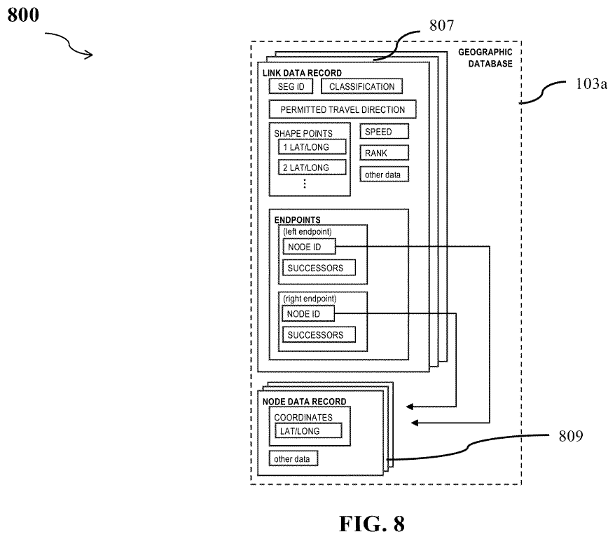

FIG. 8 shows the format of the map data 800 stored in the map database 103a according to one or more example embodiments. FIG. 8 shows a link data record 807 that may be used to store data about one or more of the feature lines. This link data record 807 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 807 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer select one or more shape points along the other-than-straight road portion. Shape point data included in the link data record 807 indicate the position, (e.g., latitude, longitude, and optionally, altitude or elevation) of the selected shape points along the represented link.

Additionally, in the compiled geographic database, such as a copy of the map database 103a, there may also be a node data record 809 for each node. The node data record 809 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate the performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

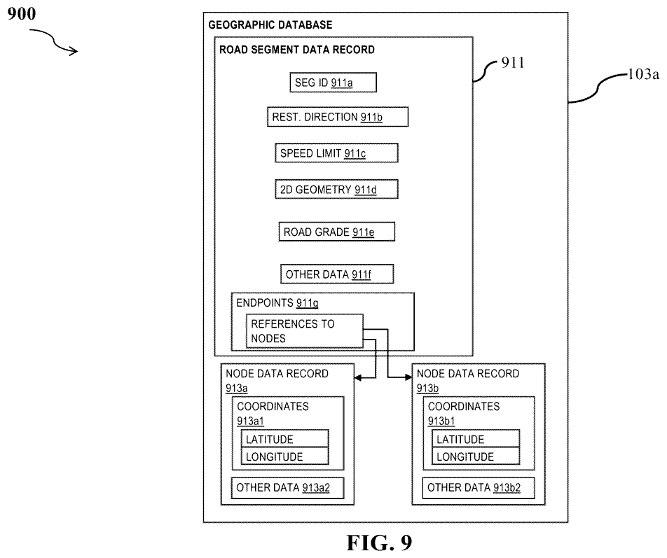

FIG. 9 shows another format of the map data 200c stored in the map database 103a according to one or more example embodiments. In the FIG. 9, the map data 200c is stored by specifying a road segment data record 811. The road segment data record 811 is configured to represent data that represents a road network. In FIG. 9, the map database 103a contains at least one road segment data record 811 (also referred to as “entity” or “entry”) for each road segment in a geographic region.

The map database 103a that represents the geographic region of FIG. 1 also includes a database record 913 (a node data record 913a and a node data record 913b) (or “entity” or “entry”) for each node associated with the at least one road segment shown by the road segment data record 811. (The terms “nodes” and “segments” represent only one terminology for describing these physical geographic features and other terminology for describing these features is intended to be encompassed within the scope of these concepts). Each of the node data records 913a and 913b may have associated information (such as “attributes”, “fields”, etc.) that allows identification of the road segment(s) that connect to it and/or its geographic position (e.g., its latitude and longitude coordinates).

FIG. 9 shows some of the components of the road segment data record 811 contained in the map database 103a. The road segment data record 811 includes a segment ID 811a by which the data record can be identified in the map database 103a. Each road segment data record 811 has associated with it information (such as “attributes”, “fields”, etc.) that describes features of the represented road segment. The road segment data record 811 may include data 811b that indicates the restrictions, if any, on the direction of vehicular travel permitted on the represented road segment. The road segment data record 811 includes data 811c that indicates a static speed limit or speed category (i.e., a range indicating a maximum permitted vehicular speed of travel) on the represented road segment. The static speed limit is a term used for speed limits with a permanent character, even if they are variable in a pre-determined way, such as dependent on the time of the day or weather. The static speed limit is the sign-posted explicit speed limit for the road segment or the non-sign-posted implicit general speed limit based on legislation.

The road segment data record 811 may also include data 811d indicating the two-dimensional (“2D”) geometry or shape of the road segment. If a road segment is straight, its shape can be represented by identifying its endpoints or nodes. However, if a road segment is other than straight, additional information is required to indicate the shape of the road. One way to represent the shape of an other-than-straight road segment is to use shape points. Shape points are points through which a road segment passes between its endpoints. By providing the latitude and longitude coordinates of one or more shape points, the shape of an other-than-straight road segment can be represented. Another way of representing other-than-straight road segments is with mathematical expressions, such as polynomial splines.

The road segment data record 811 also includes road grade data 811e which indicates the grade or slope of the road segment. In one embodiment, the road grade data 811e includes road grade change points and a corresponding percentage of grade change. Additionally, the road grade data 811e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and the percentage of grade change indicates a percentage increase or decrease of the grade or slope. Each road segment may have several grade change points depending on the geometry of the road segment. In another embodiment, the road grade data 811e includes the road grade change points and an actual road grade value for the portion of the road segment after the road grade change point until the next road grade change point or end node. In a further embodiment, the road grade data 811e includes elevation data at the road grade change points and nodes. In an alternative embodiment, the road grade data 811e is an elevation model which may be used to determine the slope of the road segment.

The road segment data record 811 also includes data 811g providing the geographic coordinates (e.g., the latitude and longitude) of the endpoints of the represented road segment. In one embodiment, the data 811g are references to the node data records 811 that represent the nodes corresponding to the endpoints of the represented road segment.

The road segment data record 811 may also include or be associated with other data 81 1f that refer to various other attributes of the represented road segment. The various attributes associated with a road segment may be included in a single road segment record or may be included in more than one type of record which cross-reference each other. For example, the road segment data record 811 may include data identifying the name or names by which the represented road segment is known, the street address ranges along the represented road segment, and so on.

FIG. 9 also shows some of the components of the node data record 913 contained in the map database 103a. Each of the node data records 913 may have associated information (such as “attributes”, “fields”, etc.) that allows identification of the road segment(s) that connect to it and/or it is geographic position (e.g., its latitude and longitude coordinates). For the embodiment shown in FIG. 9, the node data records 913a and 913b include the latitude and longitude coordinates 913a1 and 913b1 for their nodes. The node data records 913a and 913b may also include other data 913a2 and 913b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include the road level layer, lane level layer, and localization layer. The data is stored in the map database 103a in the formats shown in FIGS. 8 and 9 may be combined appropriately to provide these three or more layers of information. In some embodiments, there may be fewer or fewer layers of data also possible, without deviating from the scope of the present disclosure.

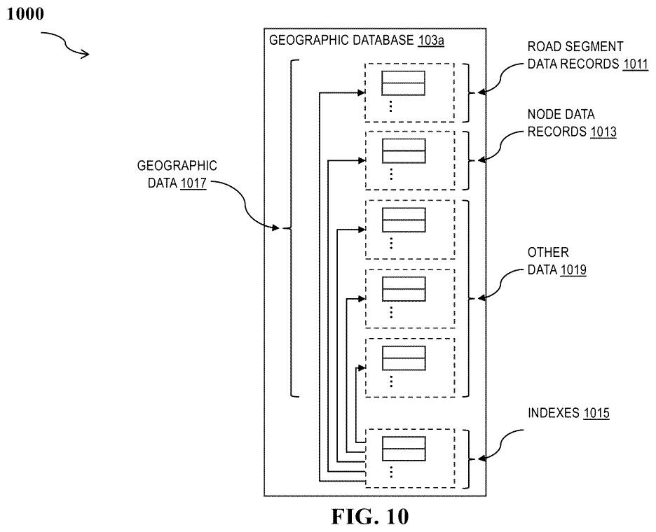

FIG. 10 illustrates a block diagram 1000 of the map database 103a storing map data or geographic data 1017 in the form of road segments/links, nodes, and one or more associated attributes as discussed above. Furthermore, attributes may refer to features or data layers associated with the link-node database, such as an HD lane data layer.

In addition, the map data 1017 may also include other kinds of data 1019. The other kinds of data 1019 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexed 1015. Indexes 1015 may include various types of indexes that relate the different types of data to each other or that relate to other aspects of the data contained in the geographic database 103a.

The data stored in the map database 103a in the various formats discussed above may help in providing precise data for high-definition mapping applications, autonomous vehicle navigation and guidance, cruise control using ADAS, direction control using accurate vehicle maneuvering, and other such services. In some embodiments, the UAV 101 accesses the map database 103a storing data in the form of various layers and formats depicted in FIG. 8. FIG. 9, and FIG. 10.

We claim:

1. An unmanned aerial vehicle (UAV) comprising:
processor configured to:
control an image sensor to capture an image of a geographical region;
detect a first object of a set of objects in the captured image based on a segmentation of the captured image into one or more segments;
generate an association between the detected first object and the captured image; and
transmit the generated association to a map database.

2. The UAV of claim 1, wherein the processor is further configured to:
determine location information associated with the geographical region based on the captured image; and
transmit the determined location information to the map database.

3. The UAV of claim 1, wherein the processor is further configured to:
control a location sensor to capture location information associated with the geographical region; and
transmit the captured location information to the map database.

4. The UAV of claim 1, wherein the processor is further configured to:
apply a first machine learning (ML) model on the one or more segments of the captured image, wherein the ML model is trained using a training dataset; and
detect the first object in the captured image based on the application of the first ML model on the one or more segments.

5. The UAV of claim 4, wherein the processor is further configured to:
retrieve, for training the first ML model, the training dataset associated with the detection of the set of objects in a training image; and
train the first ML model based on the retrieved training dataset.

6. The UAV of claim 1, wherein the processor is further configured to:
apply a second machine learning (ML) model on the detected first object and the captured image; and
generate the association between the detected first object and the captured image based on the application of the second ML model on the detected first object and the captured image.

7. The UAV of claim 1, wherein the UAV comprises of a memory and wherein the processor is further configured to:
detect a network event indicative of a disruption in a network connection of the UAV with the map database; and
store the generated association in the memory based on the detection of the network event.

8. The UAV of claim 1, wherein the processor is further configured to:
receive one or more navigation commands associated with navigation of the UAV from a user device;
control navigation of the UAV towards the geographical region based on the received one or more navigation commands; and
control the image sensor to capture the image of the geographical region based on a determination that the UAV is over the geographical region.

9. The UAV of claim 1, wherein the processor is further configured to:
segment, using a master process, the captured image into the one or more segments; and
allocate, using the master process, the one or more segments of the image to one or more cores of the processor of the UAV.

10. The UAV of claim 1, wherein the processor is further configured to:
determine count data associated with one or more cores of the processor of the UAV;
segment the captured image into one or more segments based on the determined count data; and
detect the first object in the captured image using one or more cores of the processor of the UAV.

11. The UAV of claim 10, wherein the count data is indicative of a number of available cores of the processor of the UAV, for detecting the first object in the captured image.

12. The UAV of claim 1, wherein each of the one or more segments of the image is associated with a segment identifier, and wherein each of one or more cores of the processor is associated with a core identifier.

13. The UAV of claim 12, wherein the processor is further configured to combine each of the one or more segments of the image based on the segment identifier and the core identifier.

14. A method comprising:
controlling, by an electronic device, an image sensor to capture an image of a geographical region;
detecting, by the electronic device, a first object of a set of objects in the captured image based on a segmentation of the captured image into one or more segments;
generating, by the electronic device, an association between the detected first object and the captured image; and
transmitting, by an electronic device, the generated association to a map database.

15. The method of claim 14, wherein the electronic device corresponds to an unmanned aerial vehicle (UAV).

16. The method of claim 14, further comprising:
applying, by the electronic device, a first machine learning (ML) model on the one or more segments of the captured image, wherein the ML model is a trained using a training dataset; and
detecting, by the electronic device, the first object in the captured image based on the application of the first ML model on the one or more segments.

17. The method of claim 14, further comprising:
applying, by the electronic device, a second machine learning (ML) model on the detected first object and the captured image; and
generating, by the electronic device, the association between the detected first object and the captured image based on the application of the second ML model on the detected first object and the captured image.

18. The method of claim 14, further comprising:
receiving, by the electronic device, one or more navigation commands associated with navigation of the electronic device from a user device;
controlling, by the electronic device, navigation of the electronic device towards the geographical region based on the received one or more navigation commands; and
controlling, by the electronic device, the image sensor to capture the image of the geographical region based on a determination that the electronic device is over the geographical region.

19. A non-transitory computer-readable storage medium having computer program code instructions stored therein, the computer program code instructions, when executed by an unmanned aerial vehicle (UAV), cause the UAV to:
control one or more sensors to capture sensor data corresponding to a geographical region;
process the captured sensor data using one or more cores of the processor to detect a first object of a set of objects based on segmentation of the captured sensor data;
generate an association between the detected first object and the captured sensor data; and
transmit the generated association to a map database.

20. The non-transitory computer-readable storage medium of claim 19, wherein the one or more sensors comprises a galvanometer sensor, a hall effect magnetometer sensor, a corona discharge meter sensor, and a non-contact voltage tester sensor.

21. The non-transitory computer-readable storage medium of claim 19, wherein the one or more sensors comprises of an image capture sensor, and wherein the sensor data corresponds to an image of the geographical region.
